(19) United States
(12) Patent Application Publication
(10) Pub. No.: US 2021/0341562 A1
(43) Pub. Date: Nov. 4, 2021

(54) BEAM BASED POSITIONING MEASUREMENTS AND MEASUREMENT REPORTING

(71) Applicant: Telefonaktiebolaget LM Ericsson (publ), Stockholm (SE)

(72) Inventors: Per ERNSTRÖM, Stockholm (SE); Fredrik GUNNARSSON, Linköping (SE); Nicklas JOHANSSON, Linköping (SE); Sara MODARRES RAZAVI, Linköping (SE); Satyam DWIVEDI, Solna (SE); Ritesh SHREEVASTAV, Upplands Vasby (SE); Deep SHRESTHA, Linkoping (SE)

(21) Appl. No.: 17/282,596

(22) PCT Filed: Oct. 4, 2019
(86) PCT No.: PCT/SE2019/050967

§ 371 Date: Apr. 2, 2021

Related U.S. Application Data
(60) Provisional application No. 62/741,657, filed on Oct. 5, 2018.

(51) Int. Cl. G01S 5/00; G01S 5/02

(52) U.S. Cl. CPC G01S 5/0036; G01S 5/0295

(57) ABSTRACT

Methods and apparatuses are disclosed for beam based positioning measurements and measurement reporting. In one embodiment, a method in a network node includes communicating information to configure a wireless device (WD) with a plurality of positioning reference signals, the communicated information at least indicating which of the plurality of positioning reference signals are transmitted from the same transmission point. In another embodiment, a method in a WD includes receiving information indicating which of a plurality of positioning reference signals are transmitted from the same transmission point, and performing measurements on each of the plurality of positioning reference signals transmitted from the same transmission point.

### FIELD

The present disclosure relates to wireless communications, and in particular, to beam-based positioning measurements and measurement reporting.

### INTRODUCTION

Positioning has been a topic in Long Term Evolution (LTE) standardization since the Third Generation Partnership Project (3GPP) Release 9 standards. One objective is to fulfill regulatory requirements for emergency call positioning. Positioning in New Radio (NR) (also referred to as “5G”) may be supported by the architecture shown, for example, in FIG. 1. It should be noted that the network nodes gNB and ng-eNB shown in FIG. 1 may not always both be present and when both gNB and ng-eNB network nodes are present, the NG-C interface may only be present for one of them.

The Location Management Function (LMF) may be the location server in NR. There may also be interactions between the location server and the network node (e.g., gNodeB) via, for example, the NR Positioning Protocol A (NRPPa protocol). The interactions between the network node and the device may be supported via the Radio Resource Control (RRC) protocol.

In legacy LTE, the following techniques may be supported:
Enhanced Cell ID: Essentially, cell identifier (ID) information to associate the device (e.g., wireless device) to the serving area of a serving cell, and then additional information to determine a finer granularity position.
Assisted Global Navigation Satellite System (GNSS): GNSS information retrieved by the device, supported by assistance information provided to the device from Evolved-Serving Mobile Location Center (E-SMLC).
Observed Time Difference of Arrival (OTDOA): The device estimates the time difference of reference signals from different base stations and sends to the E-SMLC for multi-lateration.
Uplink TDOA (UTDOA): The device is requested to transmit a specific waveform, i.e., signal, that is detected by multiple location measurement units (e.g., an eNB) at known positions. These measurements are forwarded to E-SMLC for multilateration

According to an NR positioning study item for Release (Rel.) 16, the 3GPP NR radio-technology may be positioned to provide added value in terms of enhanced location capabilities. The operation in low and high frequency bands (i.e., below and above 6 GHz) and utilization of massive antenna arrays can provide additional degrees of freedom to improve the positioning accuracy. The possibility to use wide signal bandwidth in low and especially in high bands can provide new performance bounds for user location for well-known positioning techniques based on OTDOA and UTDOA, Cell-ID or E-Cell-ID etc., utilizing timing measurements to locate a wireless device (WD) or user equipment (UE). The recent advances in massive antenna systems (massive Multiple Input Multiple Output (MIMO)) can provide additional degrees of freedom to enable more accurate user location by exploiting spatial and angular domains of a propagation channel in combination with time measurements.

With 3GPP Release 9, Positioning Reference Signals (PRSs) were introduced for, e.g., antenna port 6 as the Release 8 cell-specific reference signals (CRSs) may not be sufficient for positioning. One simple reason may be that the required high probability of detection could not be guaranteed. A neighbor cell with its synchronization signals (Primary-/Secondary Synchronization Signals) and reference signals is seen as detectable, when the Signal-to-Interference-and-Noise Ratio (SINR) is at least −6 dB. Simulations during standardization have shown that this can be only guaranteed for 70% of all cases for the 3rd best-detected cell, means 2nd best neighboring cell. This may not be enough and has been assumed an interference-free environment, which cannot be ensured in a real-world scenario. However, PRS still has some similarities with cell-specific reference signals as defined in 3GPP Release 8. PRS may be a pseudo-random quadrature phase shift keying (QPSK) sequence that is mapped in diagonal patterns with shifts in frequency and time to avoid collision with cell-specific reference signals and an overlap with the control channels (e.g., Physical Downlink Control Channel (PDCCH)).

The LTE standard PRS may provide three layers of isolation to improve hearability (i.e., the ability to detect weak neighbor cells) as compared with older solutions, including:
1. Code domain: Each cell transmits a different PRS sequence (orthogonal to other PRS sequences in the code domain).
2. Frequency domain: PRS has a frequency re-use of six, i.e., six possible frequency arrangements (called “frequency offset”), which are defined within the PRS bandwidth. If two cells have the same frequency offset, the PRSs collide in the frequency domain. In such cases, the isolation from the orthogonal PRS sequences can distinguish one cell from the other.
3. Time domain: If PRSs collide in the frequency domain, muting (e.g., time-based blanking) can make the PRS occasions again appear orthogonal to each other.

In NR, positioning has not yet been specified but some of the reference signals specified for other purposes could also be utilized for positioning. As an example, the Channel State Information Reference Signal (CSI RS) for tracking could be utilized for time of arrival (TOA) measurements. A Rel. 16 study item has been started in 3GPP to introduce positioning services. This may lead to the introduction of measurements based on already existing reference signals and/or the introduction of new reference signals for positioning. However, the transmission, measurement and reporting on the various reference signals may result in large signaling overhead that actually has little to no impact on positioning accuracy.

In particular, for all RSTD measurement for all PRSs for a set of transmission points, when the UE is configured to measure on multiple PRSs transmitted from the same transmission point e.g. in different beams, would result in a large signaling overhead

### SUMMARY

Some embodiments advantageously provide methods and apparatuses for beam based positioning measurements and measurement reporting.

In one aspect of this disclosure, a network node is configured to communicate information to configure the wireless device (WD) with a plurality of positioning reference signals, the communicated information at least indicating which of the plurality of positioning reference signals are transmitted from the same transmission point.

In another aspect of this disclosure, a method implemented in a network node is provided. The method includes communicating information to configure a wireless device with a plurality of positioning reference signals, the communicated information at least indicating which of the plurality of positioning reference signals are transmitted from the same transmission point.

In another aspect of this disclosure, a wireless device (WD) is configured to receive information indicating which of a plurality of positioning reference signals are transmitted from the same transmission point; and perform measurements on each of the plurality of positioning reference signals transmitted from the same transmission point.

In another aspect of this disclosure, a method implemented in a wireless device is provided. The method includes receiving information indicating which of a plurality of positioning reference signals are transmitted from the same transmission point and performing measurements on each of the plurality of positioning reference signals transmitted from the same transmission point.

In yet another aspect of this disclosure, a transmission node, which may also be a network node, is configured to obtain configuration information for a plurality of positioning reference signals; determine a waveform for each of the plurality of positioning reference signals corresponding to the obtained configuration information; and cause a transmission of the determined waveforms for each of the plurality of positioning reference signals.

In yet another aspect of this disclosure, a method implemented in a transmission node is provided. The method includes obtaining configuration information for a plurality of positioning reference signals. The method further includes determining a waveform for each of the plurality of positioning reference signals corresponding to the obtained configuration information and causing a transmission of the determined waveforms for each of the plurality of positioning reference signals.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of Next Generation Radio Access Network (NG-RAN) Rel-15 LCS Protocols;

FIG. 2 illustrates an example of a wireless device (WD) receiving multiple beams from a transmission point, where the WD performs multiple reference signal time difference (RSTD) measurements on a PRS received on every beam;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an exemplary process in a network node for a Configuration unit according to some embodiments of the present disclosure;

FIG. 10 is a flowchart of an alternative exemplary process in a network node for a Configuration unit according to some embodiments of the present disclosure; and

FIG. 11 is a flowchart of an exemplary process in a wireless device for a Measurement unit according to some embodiments of the present disclosure.

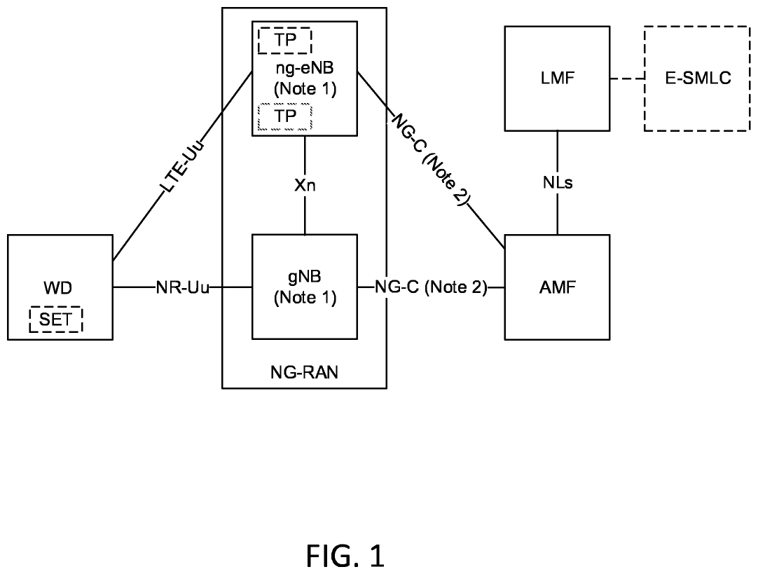

### DETAILED DESCRIPTION

Reference Signal Time Difference (RSTD) measurements for a pair of transmission points has not been defined for the case when the WD is configured to measure on multiple PRSs transmitted from the same transmission point e.g., in different beams.

Furthermore, reporting of RSTD for all PRSs (e.g., corresponding to different beams and/or different transmission points) could result in a large signaling overhead and/or reporting of measurements that have little or no impact on the positioning accuracy.

Thus, some embodiments of this disclosure describe how the WD can perform and report RSTD measurements when multiple PRSs are transmitted from the same transmission point, e.g., in different transmitted beams.

In some embodiments, the different PRS's transmitted from the same or different transmission points may be differentiated from each other e.g., by the use of different resource elements in the time frequency grid and/or by the use of different sequences.

Brief summary from the network perspective:

In some embodiments, a network node configures the WD with a number of reference signals to use for positioning measurements, herein referred to as PRSs. The WD configuration can include information on which PRSs are transmitted from the same transmission point. This can be signaled, e.g., by giving each PRS a transmission point ID and including this ID in the configuration of the WD with the PRS. Alternatively, the network such as via the network node can, for each transmission point, signal to the WD a list of the PRS IDs of the PRSs that are transmitted from that transmission point.

In some embodiments, a network node receives information from a WD on rich beam based measurements and information associated to PRSs transmitted from one or more transmission points. Based on this information the WD position can be estimated. Note that, in some embodiments, the phrase “rich beam based measurements and information” is used and means that the measurements and information may include rich channel measurements such as, for example, the time of arrival and/or received power and/or angle of arrival for multiple channel taps and/or information on which beam was used for the measurement (e.g., as given by which reference signal was used for the measurement). The use of this term does, however, not preclude that the measurement and information is limited e.g., to a single TOA for a transmission point or a single RSTD for a pair of transmission points. Furthermore, use of the term also does not preclude that the measurements were based on full sector “beams”.

Brief summary from the WD perspective:

In some embodiments, the WD receives configuration information for a number of reference signals (e.g., PRSs) to use for positioning measurements. The configuration includes information on which PRSs are transmitted from the same transmission point.

In some embodiments, the WD determines rich beam based measurements and information associated to one or more transmission point.

In some embodiments, the WD reports the determined rich beam based measurements and information to a network node.

Brief summary from the transmission point perspective:

In some embodiments, the transmission point (TP) obtains configuration information for one or more PRSs from a network node.

In some embodiments, the TP provides the configuration for multiple PRSs to the location server.

In some embodiments, the transmission point determines the new waveform for each of the configured PRSs.

In some embodiments, the transmission point transmits the waveforms of each PRS.

Both MC (multi-carrier) and SC (single-carrier) waveforms have been proposed for

the 5G air-interface. The MC candidates include Cyclic-Prefix (CP)-OFDM, Windowed (W)-OFDM, Pulse-shaped (P)-OFDM, Unique-Word (UW)-OFDM, Universal-Filtered (UF)-OFDM, and Filter-Bank Multi-Carrier (FBMC) with Offset Quadrature Amplitude Modulation (OQAM), while the SC candidates include DFT-spread (Discrete Fourier Transform-s)-OFDM, and Zero-Tail (ZT)-DFT-s-OFDM. Due to its desirable features, the CP-OFDM waveform is currently used in LTE for downlink transmissions. These features include: robustness to frequency selective channel, easy integration with MIMO, very good time localization, and a low complexity baseband transceiver design. The main drawbacks of OFDM are high PAPR and poor localization in frequency. The embodiments within this disclosure is not limited to the exemplary waveforms listed above. Other waveforms may also be included in the embodiments.

Some embodiments of the principles provided in this disclosure allow for an RSTD measurement for a pair of transmissions points to be reported also in the case where the WD is configured with multiple PRSs transmitted from the same transmission point.

In some embodiments, the RSTD measurement based on multiple beamformed PRSs transmitted from each transmission point can achieve better coverage/accuracy than a measurement based on a single PRS transmitted from each transmission point for the same use of power and time-frequency resources.

Some embodiments of this disclosure give additional information on the angle of departure, which can be used to improve positioning accuracy.

In some embodiments, the calculation of TOA for a transmission point as the minimum of the TOAs estimated for the PRSs transmitted in different beams from the transmission point gives the TOA that can be expected to be closest to the TOA of a line of sight (LOS) path in line with the use of resulting RSTD measurements for triangulation.

In some embodiments, the exclusion of some beams (since they are not strong enough to give sufficiently accurate TOA measurements) can reduce the risk for underestimating the TOA for a transmission point by e.g., mistaking noise or interference for a channel tap.

In some embodiments, the received RSTD/TOA measurement results or more generally the rich beam based measurement and information can be used for position estimation and/or to optimize and reconfigure the PRSs and the PRS beams.

Before describing in detail exemplary embodiments, it is noted that the embodiments reside primarily in combinations of apparatus components and processing steps related to beam based positioning measurements and measurement reporting. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the network node may be a transmission node and may include at least one (or more) transmission point(s) for transmitting a plurality of beams to a WD. In some embodiments, the transmission point may be involved in, for example, a coordinated multipoint (CoMP) operation for a WD. In some embodiments, the transmission point may have other configurations.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

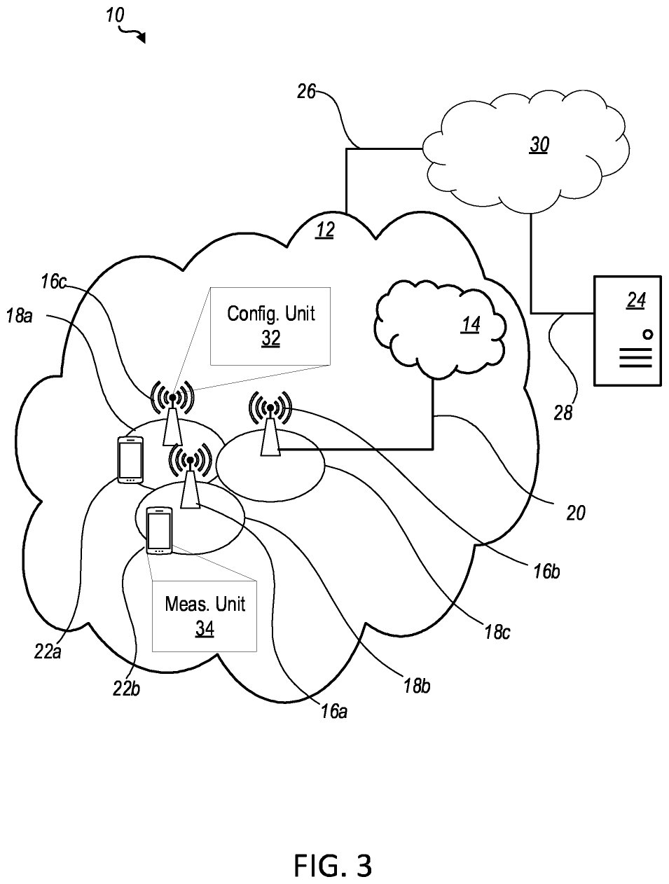

Referring now to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Configuration unit 32 which is configured to communicate information to configure the WD 22 with a plurality of positioning reference signals, the communicated information at least indicating which of the plurality of positioning reference signals are transmitted from the same transmission point.

In some embodiments, the network node 16 may include a transmission point and may be considered a transmission node. In such embodiments, the network node 16 may include a Configuration unit 32 which is configured to obtain configuration information for a plurality of positioning reference signals; determine a waveform for each of the plurality of positioning reference signals corresponding to the obtained configuration information; and cause a transmission of the determined waveforms for each of the plurality of positioning reference signals.

The network node may comprise a transmission point (TP). The transmission point may include an antenna which may be a Multiple-Input Multiple-Output (MIMO) antenna including two or more antennas. The WD is thereby, via network node and the transmission point, enabled to access services of, and exchange data with service network.

A wireless device 22 is configured to include a Measurement unit 34 which is configured to receive information indicating which of a plurality of positioning reference signals are transmitted from the same transmission point; and perform measurements on each of the plurality of positioning reference signals transmitted from the same transmission point.

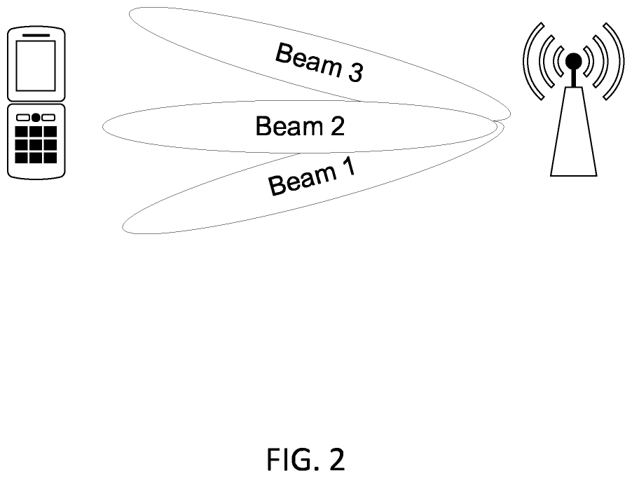

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a Monitor unit 54 configured to enable the service provider to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Configuration unit 32 configured to communicate information to configure the WD 22 with a plurality of positioning reference signals, the communicated information at least indicating which of the plurality of positioning reference signals are transmitted from the same transmission point.

In some embodiments, the communicated information includes a transmission point identifier for each of the plurality of positioning reference signals, the transmission point identifier identifying a transmission point of a corresponding positioning reference signal. In some embodiments, the processing circuitry 68 is further configured to receive information corresponding to a reference signal time difference (RSTD) measurement from the WD 22, the RSTD based at least in part on measurements performed on the plurality of positioning reference signals; and based on the received information, estimation a location of the WD 22. In some embodiments, the received information includes at least information identifying which of the plurality of positioning reference signals has a lowest measured time of arrival.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Measurement unit 34 configured to receive information indicating which of a plurality of positioning reference signals are transmitted from the same transmission point; and perform measurements on each of the plurality of positioning reference signals transmitted from the same transmission point.

In some embodiments, the processing circuitry 84 is configured to perform the measurements by being configured to, for each transmission point, calculate a time of arrival (TOA) as a minimum TOA of the TOAs measured on the positioning reference signals from the same transmission point; and calculate a reference signal time difference (RSTD) for at least one pair of transmission points based on the calculated TOA for each transmission point in the at least one pair of transmission points. In some embodiments, the processing circuitry 84 is further configured to report the calculated RSTD for the at least one pair of transmission points to the network node 16. In some embodiments, the report includes at least information identifying which of the plurality of positioning reference signals has a lowest measured time of arrival.

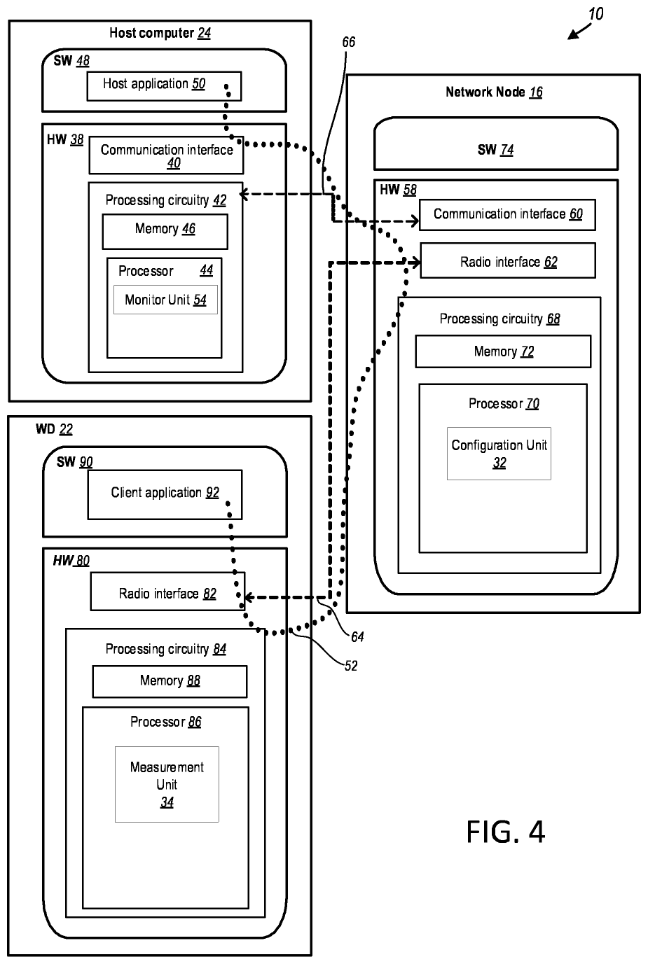

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as Configuration unit 32, and Measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

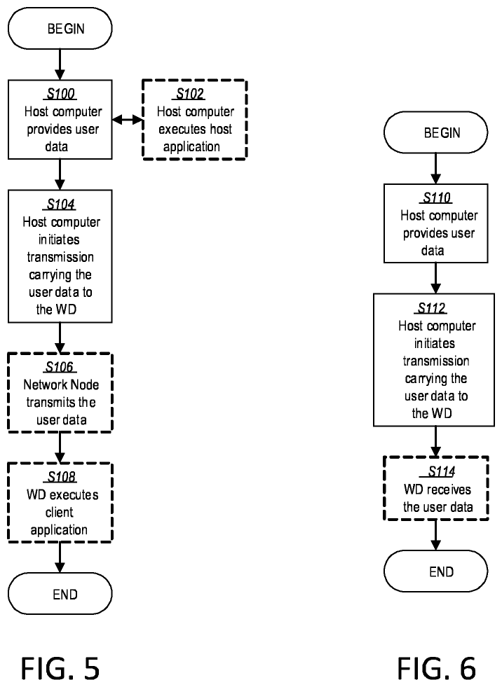

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

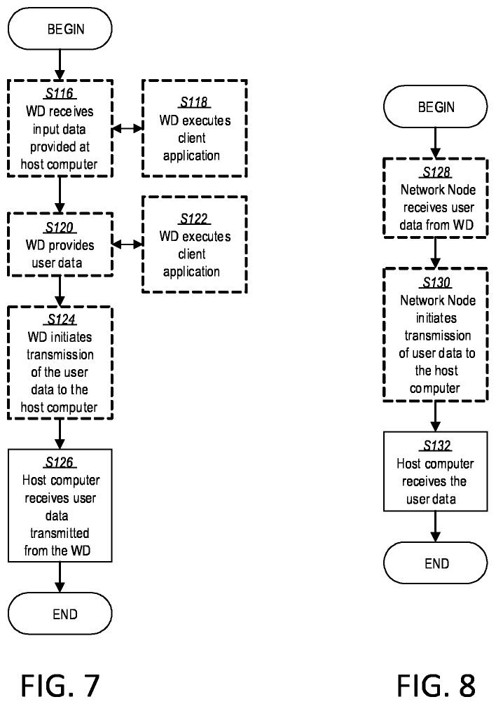

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

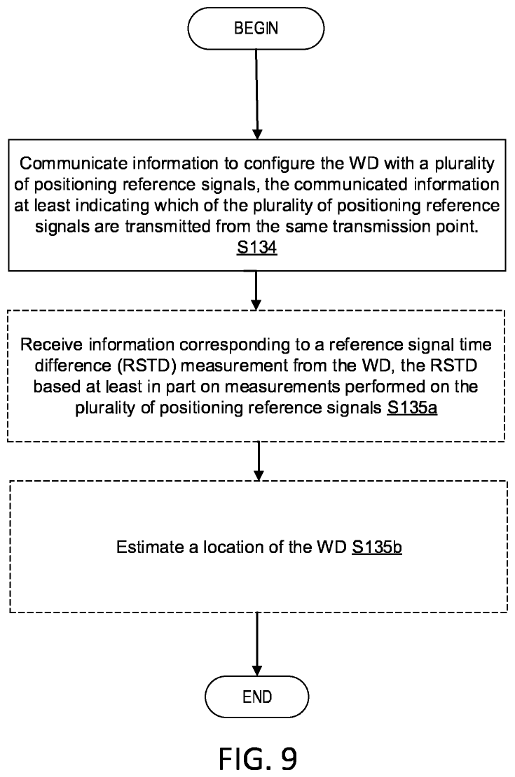

FIG. 9 is a flowchart of an exemplary process in a network node 16 according to some embodiments of the present disclosure. The method includes communicating (block S134), such as via the Configuration unit 32 and an interface such as the radio interface 62 and/or the communication interface 60, information to configure a wireless device (WD) 22 with a plurality of positioning reference signals, the communicated information at least indicating which of the plurality of positioning reference signals are transmitted from the same transmission point.

In some embodiments, the communicated information includes a transmission point identifier for each of the plurality of positioning reference signals, the transmission point identifier identifying a transmission point of a corresponding positioning reference signal. In some embodiments, (block S135a) the method further includes receiving, such as via interface such as the radio interface 62 and/or the communication interface 60 information corresponding to a reference signal time difference (RSTD) measurement from the WD 22, the RSTD based at least in part on measurements performed on the plurality of positioning reference signals; and based on the received information, estimating (block S135 b), such as via the Configuration unit 32, a location of the WD 22. In some embodiments, the received information includes at least information identifying which of the plurality of positioning reference signals has a lowest measured time of arrival.

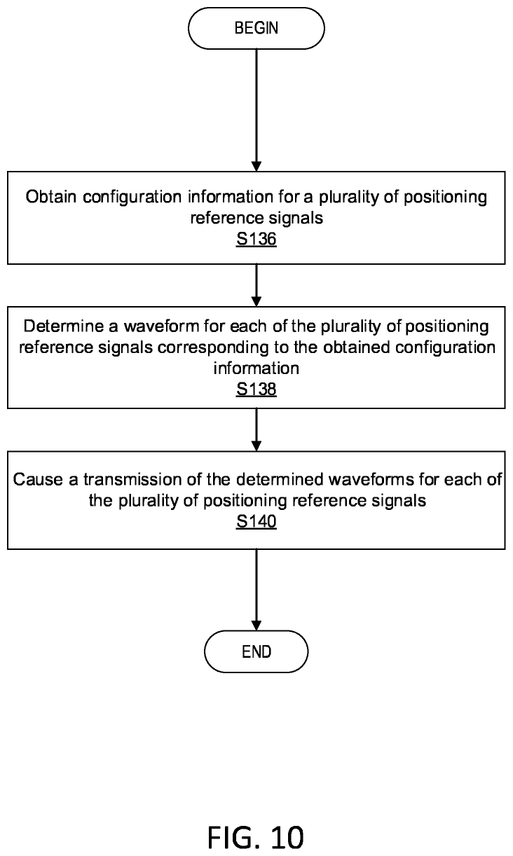

FIG. 10 is a flowchart of an alternative exemplary process in a network node 16 according to some embodiments of the present disclosure. In some embodiments, the network node 16 implementing this alternative exemplary process may include at least one or more transmission points and may be considered a transmission node. The method includes obtaining (block S136), such as via the Configuration unit 32, configuration information for a plurality of positioning reference signals. The process includes determining (block S138), such as via the Configuration unit 32, a waveform for each of the plurality of positioning reference signals corresponding to the obtained configuration information. The process includes causing (block S140) a transmission, such as via the radio interface 62, of the determined waveforms for each of the plurality of positioning reference signals. In some embodiments, the transmission node is associated with a transmission point identifier, the transmission point identifier identifying a transmission point of the transmission node for performing measurements on the transmitted plurality of positioning reference signals based at least in part on the transmission point identifier.

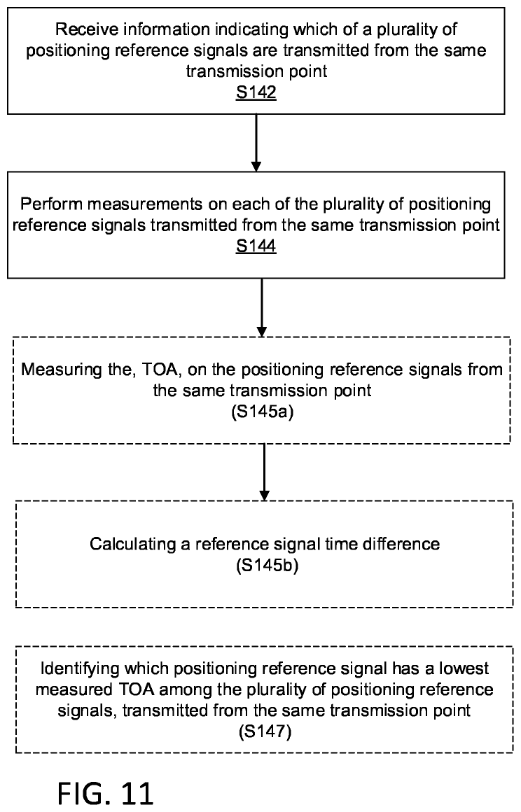

FIG. 11 is a flowchart of an exemplary process in a wireless device 22 according to some embodiments of the present disclosure. The method includes receiving (block S142), such as via the radio interface 82 and/or the Measurement unit 34, information indicating which of a plurality of positioning reference signals are transmitted from the same transmission point. The method includes performing (block S144), such as via the Measurement unit 34, measurements on each of the plurality of positioning reference signals transmitted from the same transmission point.

In some embodiments, the performing measurements further includes, for each transmission point, calculating a time of arrival (TOA) as a minimum TOA of the TOAs measured (block S145a) on the positioning reference signals from the same transmission point; and calculating (S145b) a reference signal time difference (RSTD) for at least one pair of transmission points based on the calculated TOA for each transmission point in the at least one pair of transmission points. In some embodiments, the method further includes reporting, such as via the radio interface 82 and/or the Measurement unit 34, the calculated RSTD for the at least one pair of transmission points to the network node 16 (e.g., Configuration unit 32). In some embodiments, the report includes at least information identifying which of the plurality of positioning reference signals has a lowest measured time of arrival.

Of note, although certain of the process elements described above with reference to FIGS. 9-11 are described as being performed by one or more specific elements, it is understood that such explanation is merely provided for example. It is contemplated that elements other than those specifically listed can individually or in combination perform a particular process element. Having described some embodiments for beam-based positioning measurements and measurement reporting, a more detailed description of some of the embodiments is provided below.

Device Configurations

In some embodiments, the WD 22 can be configured (e.g., by the network node 16) with respect to the scope of the rich beam based positioning measurements and information. Exemplifying configurations can include, without limitation:
If the WD 22 determines one TOA for all PRSs associated with a transmission point, or if they shall be individually reported.
If the WD 22 determines two or more signal paths per PRS associated with a transmission point.
If the WD 22 determines relative time differences between different transmission points.
If the WD 22 keeps one PRS associated with a transmission point as the reference and determines all RSTD measurements based on this particular reference.

In some embodiments, the WD 22 can be configured with an association of each PRS to a transmission point. In one embodiment, this association is implemented by the inclusion of a transmission point ID to the configuration information for each PRS. In another embodiment, the association of each PRS to a transmission point is implemented as a list for each transmission point including the PRSs transmitted from the given transmission point.

In yet another embodiment, the concept of association of PRSs to/with a transmission point may be generalized to the association of PRSs to PRS groups. A PRS group could (but does not have to) include all PRSs transmitted from the same transmission group. In this embodiment, the association of a PRS to a PRS group may replace the association of a PRS to a transmission point and the WD 22 can e.g., be configured to report one TOA for each PRS or one TOA for each PRS group.

In one embodiment, the WD 22 may receive the PRS assistance or association information in the format of two lists, one list may be a list suggesting the potential reference PRSs, while the other list may be a list suggesting neighbor PRSs. In this context, there may be two PRSs from one transmission point belonging to different reference and neighbor lists. Thus, the WD 22 may choose the reference and neighbor PRS according to the received assistance information for the RSTD measurement, or WD 22 can select the PRSs for the RSTD measurements by itself, while in both cases the selected PRSs may be reported together with the RSTD measurements.

Device Processing

In some embodiments, given a configuration with one or more transmission points, each TP configured with two or more PRSs, where different PRSs from a transmission point can be associated to different beams, the WD 22 can be configured to perform different processing to compile the rich beam based positioning measurements and information, as described in the following different embodiments.

In one embodiment, the WD 22 calculates the TOA for each transmission point as the minimum of the TOA measured for the PRSs transmitted from the given transmission point. In one aspect of the embodiment, the WD 22 furthermore only includes PRSs that are considered strong enough to enable a sufficiently accurate TOA measurement. In one aspect of the embodiment, the resulting TOA per transmission point is included in the rich beam based positioning measurements and information. In another aspect of the embodiment, the WD 22 calculates RSTD between different pairs of transmission points based on the TOA calculated for each transmission point, and may include such information/calculations in the rich beam based positioning measurements and information.

In another embodiment, the WD 22 includes TOA for all PRSs transmitted from each monitored transmission point in the rich beam based positioning measurements and information. The set of monitored transmission points, may be reduced depending on the quality of the measured PRSs. In one aspect, the TOA for all PRSs transmitted from a transmission point may be represented by the TOA from a reference PRS of the transmission point, and a relative TOA for other PRSs associated to the same transmission point.

In yet another embodiment, the WD 22 includes information about two or more signal paths per PRS, associated to the same transmission point. In one aspect of the embodiment, the WD 22 is configured to represent the time of each path as the time of arrival of a reference path, and a relative time difference for the other paths of the same PRS.

Report Configurations

In one embodiment, the WD 22 performs on demand RSTD reporting, meaning that while a request is received from the network node 16, the WD 22 performs RSTD measurements and sends the report in one signaling. In another embodiment, the WD 22 reports the RSTD measurements in a periodic fashion. The periodicity can be either based on certain predetermined time intervals, or in response to a triggering event, which can be assumed as a potentially new position for the WD 22.

In one embodiment, the WD 22 may report the RSTD measurement for an aggregated set of PRS occasions, while in another embodiment, the report can include a set of RSTD measurements including each PRS occasion separately.

In one embodiment, the network node 16 may have a certain type of representation of the PRS ID reporting that can include the PRS ID and the transmission point ID in one representation. In another embodiment, there may be also a pre-defined rule between the network node 16 and the WD 22 on the order of how the configuration of PRS IDs from the same transmission points are provided to the WD 22.

Network Node Processing

In one embodiment, a network node 16 receives rich beam based positioning measurements and information from a WD 22 and based on this (and possibly additional information received from the base stations) the network node 16 can estimate the WD 22 position.

In one embodiment, a network node 16 receives time of arrival measurements of multiple set of PRSs transmitted to a given WD 22 from different transmission points. The network node 16 may identify the best set of PRSs among all beams of the same transmission point and among all transmission points to estimate the WD 22 position. The network node 16 may identify this best set of beams from all transmission points for a given WD 22, while minimizing a cost function intending to minimize the WD 22 position estimation error. While doing this, the network node 16 may also reduce the error due to the non-LOS (NLOS) channel encountered by beams from several transmission points.

Detailed Example

Network Perspective:

A network node 16 may configure the WD 22 with a number of reference signals to use for positioning measurements, which may be referred to as PRSs. The WD 22 configuration can include information on which PRSs are transmitted from the same transmission point. This may be signaled (e.g., from the network node 16 to the WD 22) by giving each PRS a transmission point ID and including this ID in the configuration of the WD 22 with the PRS.

A network node 16 may receive information from the WD 22 on RSTD measurements and, for each transmission point, which PRS, among PRSs transmitted from the given transmission point are strong enough to enable a sufficiently accurate TOA measurements, has the lowest measured TOA, etc. Based on such information, the WD 22 position can be estimated.

WD Perspective:

In some embodiments, the WD 22 may receive configuration information for a number of reference signals (herein referred to as PRSs) to use for positioning measurements. The configuration may include information on which PRSs are transmitted from the same transmission point.

In some embodiments, the WD 22 may measure the TOA for all PRSs that are transmitted from each transmission point and may determine which are strong enough to enable a sufficiently accurate TOA measurement. In some embodiments, the WD 22 may calculate the TOA for each transmission point as the minimum of the TOA measured for the PRSs transmitted from the given transmission point and may determine which PRS(s) are strong enough to enable a sufficiently accurate TOA measurement. For each transmission point, the WD 22 can be configured to identify which PRS is among the PRSs transmitted from a given transmission point and which PRS(s) are strong enough to enable a sufficiently accurate TOA measurement, has the lowest measured TOA, etc. In some embodiments, the WD 22 may calculate the RSTD between different pairs of transmission points based on the TOA calculated for each transmission point. In some embodiments, the WD 22 may report (e.g., to the network node 16) the RSTD for the different pairs of transmission points. For each transmission point, the WD 22 may report which PRS is among PRSs transmitted from the given transmission point and which are strong enough to enable a sufficiently accurate TOA measurement, has the lowest measured TOA, etc.

Transmission Point Perspective:

The transmission point may obtain configuration information for multiple PRSs. In some embodiments, the TP may provide the configuration for multiple PRSs to the location server. In some embodiments, the transmission point may determine the new waveform for each of the configured PRSs. In some embodiments, the transmission point may transmit the waveforms of each PRS.

Some embodiments of this disclosure provide principles for the extension of the RSTD measurement to the case where a WD 22 is configured with multiple PRSs transmitted from the same transmission point.

In some embodiments, the calculation of a RSTD between transmission points based on the TOA for individual PRSs may be performed in one or more the following two steps:
The WD 22 calculates the TOA for each transmission point as the minimum of the TOA measured for the PRS beams transmitted from the given transmission point and which are strong enough to enable a sufficiently accurate TOA measurement; and
The WD 22 calculates RSTD between different pairs of transmission points based on the TOA calculated for each transmission point.

Some embodiments of this disclosure provide for the identification and reporting of which PRS is among PRSs transmitted from the given transmission point and which are strong enough to enable a sufficiently accurate TOA measurement, has the lowest measured TOA, etc.

Moreover, the network node 16 can also exploit the reported estimated TOA from the PRSs transmitted from the same transmission point or port along with the angle of departure of the beams of the PRSs to estimate the location of a WD 22.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. Generally, for DL communication, the network node 16 is the transmitter and the receiver is the WD 22. Generally, for the UL communication, the transmitter is the WD 22 and the receiver is the network node 16.

Although the description herein may be explained in the context of a positioning reference signal, it should be understood that the principles may also be applicable to other types of signals, such as other types of reference signals.

Any two or more embodiments described in this disclosure may be combined in any way with each other.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” or “measurement” used herein may refer to any measurement performed on radio signals, such as positioning reference signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

An indication (e.g., information indicating which of the plurality of positioning reference signals are transmitted from the same transmission point, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Configuring a radio node, in particular a terminal or WD (e.g., WD 22), may refer to the radio node being adapted or caused or set and/or instructed to operate according to the configuration (e.g., to measure a plurality of reference signals). Configuring may be done by another device, e.g., a network node (e.g., network node 16) (for example, a base station or gNB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilize, and/or be adapted to utilize, its circuitry/ies for configuring. Allocation information may be considered a form of configuration data. Configuration data may comprise and/or be represented by configuration information, and/or one or more corresponding indications and/or message/s.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device 22). Alternatively, or additionally, configuring a radio node, e.g., by a network node 16 or other device, may include receiving configuration data and/or data pertaining to configuration data, e.g., from another node like a network node 16, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD 22) may comprise configuring the WD 22 to perform certain measurements on certain subframes or radio resources and reporting such measurements according to embodiments of the present disclosure.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| NR | New Radio |
| OTDOA | Observed Time Difference of Arrival |
| PDP | Power Delay Profile |
| LOS | Line of Sight |
| NLOS | Non-Line of Sight |
| TDOA | Time Difference of Arrival |
| TRS | Tracking Reference Signal |
| RSTD | Reference Signal Time Difference |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A network node configured to communicate with a wireless device (WD), the network node configured to, and/or comprising a radio interface and/or comprising processing circuitry configured to:

communicate information to configure the WD with a plurality of positioning reference signals, the communicated information at least indicating which of the plurality of positioning reference signals are transmitted from the same transmission point.

Embodiment A2. The network node of Embodiment A1, wherein the communicated information includes a transmission point identifier for each of the plurality of positioning reference signals, the transmission point identifier identifying a transmission point of a corresponding positioning reference signal.

Embodiment A3. The network node of Embodiment A1, wherein the processing circuitry is further configured to:

receive information corresponding to a reference signal time difference (RSTD) measurement from the WD, the RSTD based at least in part on measurements performed on the plurality of positioning reference signals; and

based on the received information, estimate a location of the WD.

Embodiment A4. The network node of Embodiment A3, wherein the received information includes at least information identifying which of the plurality of positioning reference signals has a lowest measured time of arrival.

Embodiment B1. A method implemented in a network node, the method comprising:

communicating information to configure a wireless device (WD) with a plurality of positioning reference signals, the communicated information at least indicating which of the plurality of positioning reference signals are transmitted from the same transmission point.

Embodiment B2. The method of Embodiment B1, wherein the communicated information includes a transmission point identifier for each of the plurality of positioning reference signals, the transmission point identifier identifying a transmission point of a corresponding positioning reference signal.

Embodiment B3. The method of Embodiment B1, further comprising:

receiving information corresponding to a reference signal time difference (RSTD) measurement from the WD, the RSTD based at least in part on measurements performed on the plurality of positioning reference signals; and

based on the received information, estimating a location of the WD.

Embodiment B4. The method of Embodiment B3, wherein the received information includes at least information identifying which of the plurality of positioning reference signals has a lowest measured time of arrival.

Embodiment C1. A wireless device (WD) configured to communicate with a network node, the WD configured to, and/or comprising a radio interface and/or processing circuitry configured to:

receive information indicating which of a plurality of positioning reference signals are transmitted from the same transmission point; and

perform measurements on each of the plurality of positioning reference signals transmitted from the same transmission point.

Embodiment C2. The WD of Embodiment C1, wherein the processing circuitry is configured to perform the measurements by being configured to:

for each transmission point, calculate a time of arrival (TOA) as a minimum TOA of the TOAs measured on the positioning reference signals from the same transmission point; and

calculate a reference signal time difference (RSTD) for at least one pair of transmission points based on the calculated TOA for each transmission point in the at least one pair of transmission points.

Embodiment C3. The WD of Embodiment C2, wherein the processing circuitry is further configured to report the calculated RSTD for the at least one pair of transmission points to the network node.

Embodiment C4. The WD of Embodiment C3, wherein the report includes at least information identifying which of the plurality of positioning reference signals has a lowest measured time of arrival.

Embodiment D1. A method implemented in a wireless device (WD), the method comprising:

receiving information indicating which of a plurality of positioning reference signals are transmitted from the same transmission point; and

performing measurements on each of the plurality of positioning reference signals transmitted from the same transmission point.

Embodiment D2. The method of Embodiment D1, wherein the performing measurements further comprises:

for each transmission point, calculating a time of arrival (TOA) as a minimum TOA of the TOAs measured on the positioning reference signals from the same transmission point; and

calculating a reference signal time difference (RSTD) for at least one pair of transmission points based on the calculated TOA for each transmission point in the at least one pair of transmission points.

Embodiment D3. The method of Embodiment D2, further comprising reporting the calculated RSTD for the at least one pair of transmission points to the network node.

Embodiment D4. The method of Embodiment D3, wherein the report includes at least information identifying which of the plurality of positioning reference signals has a lowest measured time of arrival.

Embodiment E1. A transmission node configured to communicate with a wireless device (WD), the transmission node configured to, and/or comprising a radio interface and/or comprising processing circuitry configured to:

obtain configuration information for a plurality of positioning reference signals;

determine a waveform for each of the plurality of positioning reference signals corresponding to the obtained configuration information; and

cause a transmission of the determined waveforms for each of the plurality of positioning reference signals.

Embodiment E2. The transmission node of Embodiment E1, wherein the transmission node is associated with a transmission point identifier, the transmission point identifier identifying a transmission point of the transmission node for performing measurements on the transmitted plurality of positioning reference signals based at least in part on the transmission point identifier.

Embodiment F1. A method implemented in a transmission node, the method comprising:

obtaining configuration information for a plurality of positioning reference signals;

determining a waveform for each of the plurality of positioning reference signals corresponding to the obtained configuration information; and

causing a transmission of the determined waveforms for each of the plurality of positioning reference signals.

Embodiment F2. The method of Embodiment F1, wherein the transmission node is associated with a transmission point identifier, the transmission point identifier identifying a transmission point of the transmission node for performing measurements on the transmitted plurality of positioning reference signals based at least in part on the transmission point identifier.

1. A network node configured to communicate with a wireless device, WD, the network node comprising a radio interface and a processing circuitry configured to:
communicate information to configure the WD with a plurality of positioning reference signals, the communicated information at least indicating which of the plurality of positioning reference signals are transmitted from the same transmission point.

2. The network node of claim 1, wherein the communicated information comprises a transmission point identifier for each of the plurality of positioning reference signals, the transmission point identifier identifying a transmission point of a corresponding positioning reference signal.

3. The network node of claim 1, wherein the radio interface and the processing circuitry are further configured to:
receive information corresponding to a reference signal time difference (RSTD) measurement from the WD, the RSTD based at least in part on measurements performed on the plurality of positioning reference signals; and
based on the received information, estimate a location of the WD.

4. The network node of claim 3, wherein the received information includes at least information identifying which of the plurality of positioning reference signals has a lowest measured time of arrival, TOA.

5. The network node of claim 3, wherein the received information comprises, for at least one transmission point, at least information identifying which positioning reference signal has a lowest measured TOA among the plurality of positioning reference signals, transmitted from the same transmission point, that are strong enough to enable a sufficiently accurate TOA measurement.

6. A method implemented in a network node, the method comprising:
communicating information to configure a wireless device, WD, with a plurality of positioning reference signals, the communicated information at least indicating which of the plurality of positioning reference signals are transmitted from the same transmission point.

7. The method of claim 6, wherein the communicated information includes a transmission point identifier for each of the plurality of positioning reference signals, the transmission point identifier identifying a transmission point of a corresponding positioning reference signal.

8. The method of claim 6, further comprising:
receiving information corresponding to a reference signal time difference, RSTD, measurement from the WD, the RSTD based at least in part on measurements performed on the plurality of positioning reference signals; and
based on the received information, estimating a location of the WD.

9. The method of claim 8, wherein the received information includes at least information identifying which of the plurality of positioning reference signals has a lowest measured time of arrival.

10. The method of claim 8, wherein the received information comprises, for at least one transmission point, at least information identifying which positioning reference signal has a lowest measured TOA among the plurality of positioning reference signals, transmitted from the same transmission point, that are strong enough to enable a sufficiently accurate TOA measurement.

11. A wireless device, WD, configured to communicate with a network node, the WD comprising a radio interface and a processing circuitry configured to:
receive information indicating which of a plurality of positioning reference signals are transmitted from the same transmission point; and
perform measurements on each of the plurality of positioning reference signals transmitted from the same transmission point.

12. The WD of claim 11, wherein the radio interface and the processing circuitry are configured to:
for each transmission point, in at least one pair of transmission points, measure a time of arrival, TOA, on the positioning reference signals from the same transmission point; and
calculate a reference signal time difference, RSTD, for the at least one pair of transmission points based on the calculated TOA for each transmission point in the at least one pair of transmission points.

13. The WD of claim 12, wherein the radio interface and processing circuitry are further configured to:
calculate a TOA as a minimum TOA of the TOAs measured on the positioning reference signals from the same transmission point.

14. The WD of claim 12, wherein the radio interface and the processing circuitry are further configured to report the calculated RSTD for the at least one pair of transmission points to the network node.

15. The WD of claim 14, wherein the report includes at least information identifying which of the plurality of positioning reference signals, transmitted from the same transmission point, has a lowest measured time of arrival.

16. The WD of claim 14, wherein the report includes at least information identifying which positioning reference signal has a lowest measured TOA among the plurality of positioning reference signals, transmitted from the same transmission point, that are strong enough to enable a sufficiently accurate TOA measurement.

17. The WD of claim 11, wherein the radio interface and the processing circuit are further configured to:
identify which positioning reference signal has a lowest measured TOA among the plurality of positioning reference signals, transmitted from the same transmission point, that are strong enough to enable a sufficiently accurate TOA measurement.

18. A method implemented in a wireless device, WD, the method comprising:
receiving information indicating which of a plurality of positioning reference signals are transmitted from the same transmission point; and
performing measurements on each of the plurality of positioning reference signals transmitted from the same transmission point.

19. The method of claim 18, wherein the performing measurements further comprises:
for each transmission point, in at least one pair of transmission points, measuring the, TOA, on the positioning reference signals from the same transmission point; and
calculating a reference signal time difference (RSTD) for the at least one pair of transmission points based on the calculated TOA for each transmission point in the at least one pair of transmission points.

20. The method of claim 19, further comprising:
calculating a TOA as a minimum TOA of the TOAs measured on the positioning reference signals from the same transmission point.

21. The method of claim 19, further comprising:
reporting the calculated RSTD for the at least one pair of transmission points to the network node.

22. The method of claim 21, wherein the report includes at least information identifying which of the plurality of positioning reference signals has a lowest measured time of arrival.

23. The method of claim 21, wherein the report includes at least information identifying which positioning reference signal has a lowest measured TOA among the plurality of positioning reference signals, transmitted from the same transmission point, that are strong enough to enable a sufficiently accurate TOA measurement.

24. The method of claim 18, further comprising:
identifying which positioning reference signal has a lowest measured TOA among the plurality of positioning reference signals, transmitted from the same transmission point, that are strong enough to enable a sufficiently accurate TOA measurement.

25. A transmission node configured to communicate with a wireless device (WD), the transmission node comprising a radio interface and a processing circuitry configured to:
obtain configuration information for a plurality of positioning reference signals;
determine a waveform for each of the plurality of positioning reference signals corresponding to the obtained configuration information; and
cause a transmission of the determined waveforms for each of the plurality of positioning reference signals.

26. The transmission node of claim 25, wherein the transmission node is associated with a transmission point identifier, the transmission point identifier identifying a transmission point of the transmission node for performing measurements on the transmitted plurality of positioning reference signals based at least in part on the transmission point identifier.

27. A method implemented in a transmission node, the method comprising:
obtaining configuration information for a plurality of positioning reference signals;
determining a waveform for each of the plurality of positioning reference signals corresponding to the obtained configuration information; and
causing a transmission of the determined waveforms for each of the plurality of positioning reference signals.

28. The method of claim 27, wherein the transmission node is associated with a transmission point identifier, the transmission point identifier identifying a transmission point of the transmission node for performing measurements on the transmitted plurality of positioning reference signals based at least in part on the transmission point identifier.
